(19) United States
(12) Patent Application Publication
(10) Pub. No.: US 2010/0294321 A1
(43) Pub. Date: Nov. 25, 2010

(54) DISHWASHER

(75) Inventor: Michael Rosenbauer, Reimlingen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/863,997

(22) PCT Filed: Jan. 14, 2009
(86) PCT No.: PCT/EP09/50342

§ 371 Date: Jul. 22, 2010

(30) Foreign Application Priority Data
Jan. 28, 2008 (DE) 10 2008 006 352.5

(51) Int. Cl. B08B 3/00

(52) U.S. Cl. 134/25.2; 134/56 D

(57) ABSTRACT

A dishwasher having at least two washing programs for washing items to be washed, each of the at least two washing programs having at least one washing step and one rinse aid step. The dishwasher also has a heater to heat rinse aid fluid to an essentially identical maximum temperature in at least two rinse aid steps of the at least two washing programs.

The invention relates to a dishwasher according to the preamble of claim 1.

Dishwashers are known, which have a plurality of washing programs, which can be selected manually by a user or in which a washing program is selected automatically by a dishwasher controller. In addition to a normal program for washing normally soiled items to be washed, the various programs are configured for example to wash particularly heavily soiled items (intensive program) or for the gentle washing of delicate items, such as glasses (delicate program). Dishwashers are also known, which also have what are known as rapid and/or eco programs, which are optimized in respect of program duration or energy and/or water consumption.

In addition to a washing step, in which items to be washed are subjected to the action of a washing liquor containing detergents, and a rinse aid step to complete the washing program, in which the items to be washed are subjected to the action of heated water containing rinse aid, such washing programs for dishwashers can also have a pre-rinse step for eliminating coarse soiling and optionally also an intermediate rinse step.

While with a normal program the washing liquor is heated to a maximum temperature of approx. 45° C. to approx. 55° C. during the washing step and the rinse aid fluid to a maximum temperature of approx. 55° C. to approx. 65° C., with an intensive program provision is made to heat both the washing liquor and the rinse aid fluid to a maximum temperature of approx. 65° C. to approx. 75° C. With a delicate program in contrast provision is made to heat the washing liquor only to a maximum temperature of approx. 35° C. to approx. 45° C. and the rinse aid fluid to a maximum temperature of approx. 45° C. to approx. 55° C.

Modern dishwasher detergents, in particular combination products in tablet, powder, liquid or gel form, allow items to be washed at washing liquor temperatures as low as approx. 40° C. Such low-temperature dishwasher detergents cannot however be used effectively with the abovementioned programs, since with the normal and intensive programs the washing liquor is heated to temperatures well above approx. 40° C. and therefore energy is used unnecessarily to heat the washing liquor. In contrast with a delicate program the washing liquor is only heated up to a maximum of approx. 35° C. to approx. 45° C. but the low rinse aid temperature of only approx. 50° C. to 55° C. means that the drying result at the end of the washing program is frequently not satisfactory when using such a delicate program.

The object of the invention is therefore to develop a dishwasher, in particular a household dishwasher, to allow an energy-saving use of low-temperature dishwasher detergents while still achieving a satisfactory drying performance.

The object of the invention is achieved based on a dishwasher, in particular a household dishwasher, at least having two washing programs for washing items to be washed, each comprising at least one washing step and one rinse aid step.

The object of the invention is achieved in that the dishwasher heats rinse aid fluid to an essentially identical maximum temperature in at least two rinse aid steps of the at least two washing programs. This makes it possible in a simple manner for such a low-temperature dishwasher detergent to be used without unnecessary energy consumption without the drying performance being adversely affected so that an unsatisfactory drying result is achieved. It is possible here for just one of the washing programs or even the at least two or all the washing programs to be tailored for energy-saving operation with low-temperature dishwasher detergents with simultaneous optimization of the drying result.

In one preferred embodiment provision is made for the temperature difference between the maximum temperatures to be up to 10° C., in particular 5° C.

Provision is also preferably made for the dishwasher, in a first washing step of at least one washing program, to heat washing liquor to a maximum washing liquor temperature, which is lower than the maximum rinse aid fluid temperature, to which the dishwasher heats rinse aid fluid in a rinse aid step. This allows energy-optimized operation of a dishwasher without impacting negatively on the drying result. In other words the dishwasher can be designed for operation with at least two dishwasher detergents, the at least two dishwasher detergents having their optimum action with different process parameters, e.g. washing liquor temperature. Alternatively the dishwasher may only be configured for energy-optimized operation using low-temperature dishwasher detergents.

In order to achieve particularly good drying results while at the same time saving energy, provision is preferably made for the temperature difference between the maximum washing liquor temperature and the maximum rinse aid fluid temperature to be at least 10° C., in particular 15° C. Operation of a dishwasher is thus also possible with washing liquor temperatures above for example 40° C., in order to allow energy optimized operation to remove heavy soiling with low-temperature dishwasher detergents in the same manner as an intensive program with a low-temperature intensive program.

Provision is also preferably made for the washing liquor temperature essentially not to exceed 45° C. at least in one washing program during the at least one washing step and in the rinse aid step for the rinse aid fluid temperature at least briefly to be 55° C., in particular 60° C., to allow energy-saving operation. In this process the washing liquor temperature may remain below 45° C. at any point in the washing step. However in contrast it is also possible for the washing liquor temperature to exceed the maximum washing liquor temperature, for example by 10%, in particular by 5%, for a period of maximum 10%, in particular maximum 5%, of the duration of the washing step.

In contrast to remove normal soiling in the manner of a normal program, provision is preferably made for the washing liquor temperature essentially not to exceed 40° C., in particular essentially not to exceed 35° C. The washing liquor here may remain below 45° C. at any point in the washing step. In contrast however it is also possible for the washing liquor temperature to exceed the maximum washing liquor temperature, for example by 10%, in particular by 5%, for a period of maximum 10%, in particular maximum 5%, of the duration of the washing step.

In order to achieve a particularly good drying result, provision can preferably be made for the rinse aid fluid temperature to be at least briefly 70° C., in particular 75° C.

In one preferred embodiment provision is made for one of the washing programs to be configured as a low-temperature program and a further washing program to be configured as a normal program, with the dishwasher in the at least one washing step of the low-temperature program heating washing liquor to a maximum washing liquor temperature, which is lower than the maximum washing liquor temperature to which the dishwasher heats washing liquor in the at least one washing step of the normal program.

Provision is also preferably made for the circulation period of the at least one washing step of the low-temperature program to correspond at least to the circulation period of the at least one washing step of the normal program. This provides a low-temperature program that is not inferior in washing performance to a normal program, as any shortening of the washing step due to the earlier reaching of the low washing liquor temperature of for example 40° C. is compensated for by a correspondingly extended post-wash phase, in which the washing liquor, which has been heated for example to 40° C., continues to be circulated in the dishwasher at a constant temperature.

In a further preferred embodiment provision is made for a washing program to be configured as an intensive program, with the dishwasher in the at least one washing step of the intensive program heating the washing liquor to a maximum washing liquor temperature, which is higher than the maximum washing liquor temperature to which the dishwasher heats washing liquor in the at least one washing step of the normal program.

Provision is preferably made here for the circulation period of the at least one washing step of the low-temperature program to correspond at least to the circulation period of the at least one washing step of the intensive program. This provides a low-temperature program that has a comparable washing performance to an intensive program due to the extended circulation period in the washing step.

Provision is also preferably made for it to be possible for a user to select the washing programs manually. However it is also possible for a program selection to be made automatically by a dishwasher controller. It is possible here for the program selection to be based not only on the dishwasher detergent used but also on the type and quantity of items to be washed, their degree of soiling and the parameter requirements of the operator in respect of energy and/or water consumption as well as washing program duration, with both manual and automatic program selection.

To this end provision is preferably made for one selection element to be assigned to each selectable washing program or for a selection element with a number of selection options corresponding to the number of washing programs to be provided. The selection elements can be configured for example as switches or buttons or as rotary selector switches having a plurality of selection positions. To this end the selection elements are connected correspondingly to a dishwasher controller, in which the various programs are stored on storage media and which is connected to individual units of the dishwasher, such as the drain pump, the circulation pump and the flow-through heater, to control the program sequences.

In a further preferred embodiment provision is made for a first and second selection element to be provided, with at least one selectable washing program being assigned to a predetermined combination of the two selection elements. Simultaneous or successive actuation of the selection elements brings about a washing program selection here. The selection elements are connected correspondingly to a dishwasher controller, in which the various programs are stored on storage media and which is connected to individual units of the dishwasher, such as the drain pump, the circulation pump and the flow-through heater, to control the program sequences.

In a further preferred embodiment provision is made for the selectable washing programs to be assigned to at least two groups, the washing programs of the first group being assigned one selection element or one selection element with a number of selection options corresponding to the number of washing programs and it being possible to select the washing programs of the second group by simultaneous or successive actuation of the two selection elements. It is therefore possible, for example using a first selection element, to select from a normal, intensive or delicate program and using the second selection element with a low-temperature detergent to save energy by reducing the maximum washing liquor temperature, such an arrangement allowing particularly clear and easy operation.

To this end provision is preferably made for the dishwasher in at least one washing program of the second group to heat washing liquor to a maximum washing liquor temperature, which is lower than the maximum washing liquor temperature, to which the dishwasher heats washing liquor in washing programs of the first group.

The object of the invention is also achieved by a method for washing items to be washed in a dishwasher, in particular in an inventive dishwasher, at least comprising the step of selecting from at least two washing programs for washing items to be washed, each having at least one washing step and one rinse aid step, with provision being made according to the invention for rinse aid fluid to be heated to an essentially identical maximum temperature in the rinse aid steps.

Advantageous developments of the method are set out in the subclaims.

The invention is described in more detail below with reference to a drawing, in which:

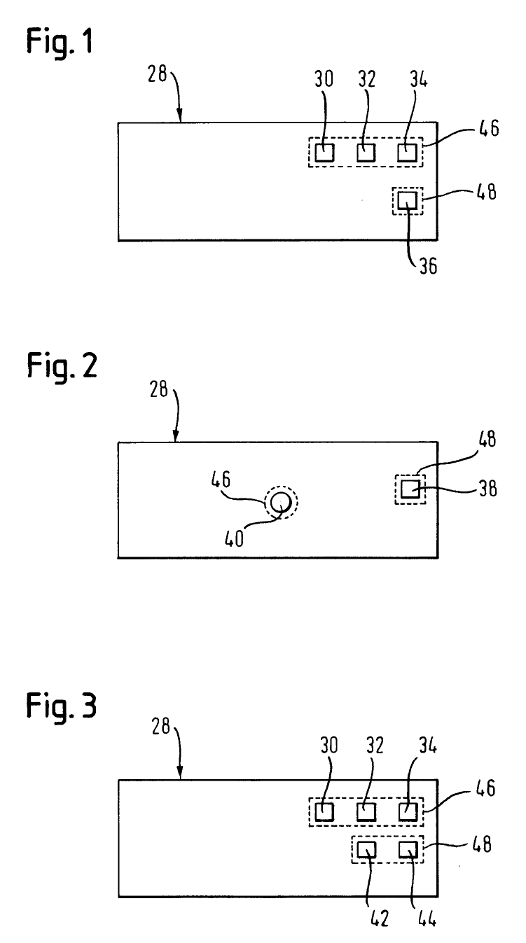

FIG. 1 shows an exemplary embodiment of a control panel of an inventive dishwasher,

FIG. 2 shows a second exemplary embodiment of a control panel of an inventive dishwasher,

FIG. 3 shows a third exemplary embodiment of a control panel of an inventive dishwasher,

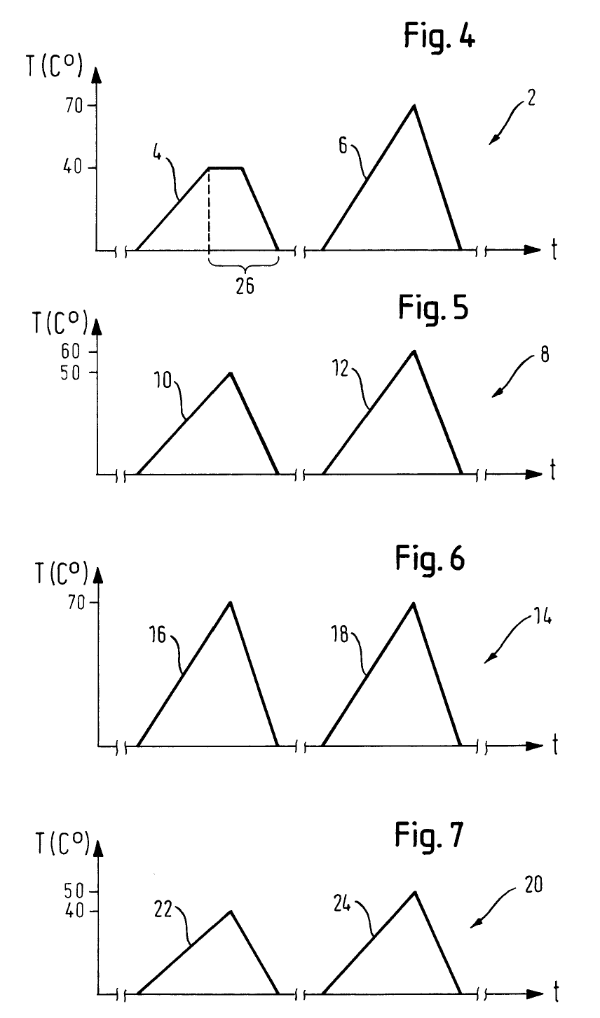

FIG. 4 shows a schematic diagram of an inventive low-temperature program,

FIG. 5 shows a schematic diagram of an normal program,

FIG. 6 shows a schematic diagram of an intensive program,

FIG. 7 shows a schematic diagram of a delicate program for a household dishwasher, and

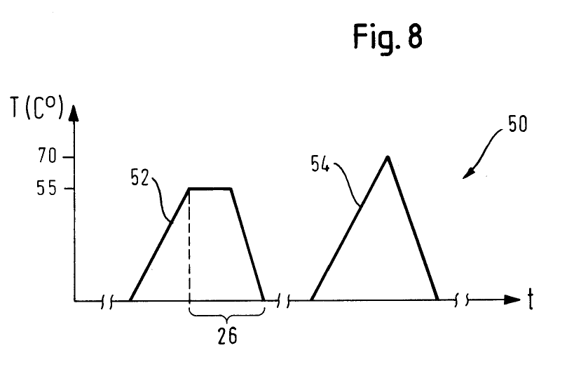

FIG. 8 shows a schematic diagram of an inventive low-temperature intensive program.

Reference is first made to FIGS. 1 to 8.

The figures show three exemplary embodiments of a control panel 28 of a dishwasher (not shown), on which selection elements configured as buttons 30, 32, 34, 38, 42, 44 or as rotary selector switches 40 in the present exemplary embodiments are disposed, being functionally connected to a controller of a dishwasher (not shown). To this end the selection elements 30, 32, 34, 38, 40, 42, 44 are connected correspondingly to the dishwasher controller, in which the various washing programs are stored on storage media and which is connected to individual units of the dishwasher, such as the drain pump, the circulation pump (neither shown) and the flow-through heater (not shown), to control the program sequences.

In the present exemplary embodiment the dishwasher has three washing programs, which are tailored for dishwasher detergents that are not effective at low temperatures. These are a normal program 8 for washing normally soiled items (see FIG. 5), an intensive program 14 for washing heavily soiled items (see FIG. 6) and a delicate program 20, for example for washing glasses and other delicate items (see FIG. 7). These washing programs 8, 14, 20 are assigned selection elements in the form of a normal program program button 30, an intensive program program selector button 32 and a delicate program program selector button 34, which combine to form a first group 46 and are disposed in a correspondingly associated manner on the control panel 28, to facilitate operation, or in other words washing program selection, for an operator. In addition to these abovementioned washing programs further washing programs are also known, for example rapid programs with a shorter duration or eco programs, which are designed for particularly low energy and water consumption. Such programs are however not shown here for reasons of clarity.

A second group 48 of washing programs is also provided, which are tailored to operate with low-temperature dishwasher detergents and to which corresponding selection elements are assigned. In the present exemplary embodiments these are a low-temperature program 2 (see FIG. 5) and an additional low-temperature intensive program 50 (see FIG. 8).

Reference is now made exclusively to FIGS. 1 to 3.

In a first exemplary embodiment (see FIG. 1) the low-temperature program 2 is selected by actuating a low-temperature program program selector button 36 assigned to the low-temperature program 2.

In contrast in the second and third exemplary embodiments an additional low-temperature intensive program 50 is provided in addition to the low-temperature program 2. A selection element of the second group 48 can be configured as a low-temperature program program selector button 38, so that it is possible to select a washing program by combined, i.e. simultaneous or successive, actuation of the selection elements 38, 40 of the first group 46 and the second group 48. Alternatively these low-temperature programs 2, 50 can be assigned selection elements in the form of a low-temperature program program selector button 42 and a low-temperature intensive program program selector button 44, which can likewise be configured as buttons for example and are disposed on the control panel 28 combined to form the second group 48 (see FIG. 3).

In the first and third exemplary embodiments (see FIGS. 1 and 3) an operator therefore selects the normal program 8, the intensive program 14 or the delicate program 20 using the normal program program button 30, intensive program program selector button 32 and delicate program program selector button 34 assigned to the respective washing programs. In the second exemplary embodiment (see FIG. 2) a rotary selector switch 40 is provided for this purpose, having a number of switching positions corresponding to the number of washing programs.

In contrast the low-temperature program 2 for low-temperature dishwasher detergent is selected using the low-temperature program program selector button 36 (see FIG. 1). Alternatively provision can also be made for the maximum washing liquor temperature of the normal program 2 and the intensive program 14 to be reduced by a predetermined value, for example by 10° C. to 20° C., by actuating the low-temperature changeover button 38, so that the low-temperature intensive program 50 is available for selection.

In the third exemplary embodiment (see FIG. 3) in addition to the normal program program button 30, the intensive program program selector button 32 and delicate program program selector button 34, for the low-temperature program 2 and the low-temperature intensive program 50 the low-temperature program program selector button 42 and a low-temperature intensive program program selector button 44 are provided, by means of which a program selection can be made.

Reference is now made to FIGS. 4 to 8.

These show the low-temperature program 2 (FIG. 4), the normal program 8 (FIG. 5), the intensive program 14 (FIG. 6) and the delicate program 20 (FIG. 7) as well as a low-temperature intensive program 50 (FIG. 8), for which pre-rinse and intermediate rinse steps are not shown for reasons of clarity.

Each of the programs 2, 8, 14, 20, 50 has a washing step 4, 10, 16, 22, 52, during which items to be washed are subjected to the action of washing liquor, i.e. water containing detergents, and a rinse aid step 6, 12, 18, 20, 54, during which the items to be washed are subjected to the action of water containing rinse aid.

An operator can use the control panel 28 of the dishwasher (not shown) to make a selection from the washing programs, depending on whether particularly heavily soiled items are to be washed intensively using an intensive program 14 or only lightly soiled items, e.g. glasses, are to be washed using a delicate program 20. To wash normally soiled goods in contrast the normal program 8 is provided, in which in the present exemplary embodiment the washing liquor is heated to a temperature of approx. 50° C. in the washing step 10, while with the intensive program 14 in the present exemplary embodiment the washing liquor is heated to a temperature of approx. 70° C. in the washing step 16. In contrast with a delicate program 20 in the present exemplary embodiment the washing liquor is heated to approx. 40° C. in the washing step 22.

In the rinse aid steps 12, 18, 24 in the present exemplary embodiments with the normal program 8 the rinse aid fluid is heated to a temperature of approx. 60° C., while with the intensive program 14 the rinse aid fluid is heated to a temperature of approx. 70° C. in the rinse aid step 18. With the delicate program 70 in the present exemplary embodiment the rinse aid fluid 24 is only heated to a temperature of approx. 50° C.

In contrast provision is made with the inventive low-temperature program 2 for the washing liquor to be heated to a temperature of approx. 40° C. in the washing step 4 in the present exemplary embodiment, while in the final rinse aid step 6 the rinse aid fluid is heated to a temperature of approx. 70° C. in the present exemplary embodiment.

To enhance washing performance during the washing step 4 of the low-temperature program, the circulation period in the washing step 4 of the low-temperature program 2 can be significantly extended compared with the washing steps 10, 16, 22 of the normal program 8, the intensive program 14 and the delicate program 20, in that the washing step 4 is continued when it reaches its maximum temperature, in the present exemplary embodiment approx. 40° C., as part of what is known as a post-wash phase 26, so that reducing the washing liquor temperature does not shorten the washing step 4 with the result that the washing action in the washing step 4 of the low-temperature program 2 is reduced compared with the other programs 8, 14, 20.

Alternatively or additionally provision can be made for the quantity of washing liquor to be increased compared with the other washing steps 10, 16, 22 of the other programs 8, 14, 20, so that the increased quantity of washing liquor produces an improved washing action.

A low-temperature intensive program 50 is also provided, with which in the present exemplary embodiment the washing liquor is heated to a temperature of approx. 55° C. in the washing step 52, while in the final rinse aid step 6 the rinse aid fluid is heated to a temperature of approx. 70° C., so that the increased washing liquor temperature produces an improved washing performance compared with the low-temperature program 2, allowing energy-saving washing of even heavily soiled items. The low-temperature intensive program 50 can also have a post-wash phase 28 to improve washing performance.

The inventive low-temperature programs therefore provide a dishwasher which allows low-temperature dishwasher detergents to be used without unnecessary energy consumption whilst maintaining the same washing and drying performances.

### LIST OF REFERENCE CHARACTERS

2 Low-temperature program
4 Washing step
6 Rinse aid step
8 Normal program
10 Washing step
12 Rinse aid step
14 Intensive program
16 Washing step
18 Rinse aid step
20 Delicate program
22 Washing step
24 Rinse aid step
26 Post-wash phase
28 Control panel
30 Normal program program button
32 Intensive program program selector button
34 Delicate program program selector button
36 Low-temperature program program selector button
38 Low-temperature changeover button
40 Rotary selector switch
42 Low-temperature program program selector button
44 Low-temperature intensive program program selector button
46 First group
48 Second group
50 Low-temperature intensive program
52 Washing step
54 Rinse aid step

1-32. (canceled)

33. A dishwasher, comprising:
at least two washing programs for washing items to be washed, each of the at least two washing programs having at least one washing step and at least one rinse aid step; and
a heater to heat rinse aid fluid to an essentially identical maximum temperature in at least two rinse aid steps of the at least two washing programs.

34. The dishwasher of claim 33, wherein the dishwasher is a household dishwasher.

35. The dishwasher of claim 33, wherein a temperature difference between maximum temperatures is up to 10° C.

36. The dishwasher of claim 35, wherein the temperature difference between the maximum temperatures is 5° C.

37. The dishwasher of claim 33, wherein, in a first washing step of at least one washing program, the dishwasher heats washing liquor to a maximum washing liquor temperature that is lower than a maximum rinse aid fluid temperature to which the dishwasher heats rinse aid fluid in a rinse aid step.

38. The dishwasher of claim 37, wherein a temperature difference between the maximum washing liquor temperature and the maximum rinse aid fluid temperature is at least 10° C.

39. The dishwasher of claim 38, wherein the temperature difference is 15° C.

40. The dishwasher of claim 33, wherein the dishwasher limits, in at least one washing program during the at least one washing step, a washing liquor temperature essentially to maximum 45° C., and wherein the dishwasher sets, in the rinse aid step, a rinse aid fluid temperature at least temporarily to at least 55° C.

41. The dishwasher of claim 40, wherein the rinse aid fluid temperature is at least 60° C.

42. The dishwasher of claim 40, wherein the dishwasher limits the washing liquor temperature essentially to maximum 40° C.

43. The dishwasher of claim 42, wherein the dishwasher limits the washing liquor temperature essentially to maximum 35° C.

44. The dishwasher of claim 40, wherein the dishwasher sets the rinse aid fluid at least temporarily to a temperature of 70° C.

45. The dishwasher of claim 44, wherein the dishwasher sets the rinse aid fluid at least temporarily to a temperature of 75° C.

46. The dishwasher of claim 33, wherein one of the washing programs is configured as a low-temperature program; wherein a further washing program is configured as a normal program; and wherein the dishwasher heats, in the at least one washing step of the low-temperature program, washing liquor to a maximum washing liquor temperature that is lower than a maximum washing liquor temperature to which the dishwasher heats the washing liquor in the at least one washing step of the normal program.

47. The dishwasher of claim 46, wherein a circulation period of the at least one washing step of the low-temperature program corresponds to at least a circulation period of the at least one washing step of the normal program.

48. The dishwasher of claim 46, wherein one of the washing programs is configured as an intensive program; and wherein the dishwasher heats, in the at least one washing step of the intensive program, a washing liquor to a maximum washing liquor temperature that is higher than the maximum washing liquor temperature to which the dishwasher heats the washing liquor in the at least one washing step of the normal program.

49. The dishwasher of claim 48, wherein a circulation period of the at least one washing step of the low-temperature program corresponds to at least a circulation period of the at least one washing step of the intensive program.

50. The dishwasher of claim 33, wherein the washing programs are manually selected by an operator.

51. The dishwasher of claim 50, wherein one of one selection element is assigned to each selectable washing program and a selection element with a plurality of selection options corresponding to a plurality of washing programs is provided.

52. The dishwasher of claim 50, wherein at least a first selection element and a second selection element are provided, and wherein at least one selectable washing program is assigned to a predetermined combination of the first and second selection elements.

53. The dishwasher of claim 52, wherein each of the selectable washing programs is assigned to at least one of a first group and a second group; wherein washing programs of the first group are assigned to one of one selection element and one selection element with a plurality of selection options corresponding to a plurality of washing programs; and wherein washing programs of the second group are selected by one of simultaneous and successive actuation of the two selection elements.

54. The dishwasher of claim 53, wherein, in at least one washing program of the second group, the dishwasher heats washing liquor to a maximum washing liquor temperature that is lower than a maximum washing liquor temperature to which the dishwasher heats washing liquor in washing programs of the first group.

55. A method for washing items to be washed in a dishwasher, the method comprising:
selecting from at least two washing programs for the washing items to be washed, each of the at least two washing programs having at least one washing step and at least one rinse aid step, wherein, in the at least one rinse aid step, rinse aid fluid is heated to an essentially identical maximum temperature.

56. The method of claim 55, wherein a temperature difference between the maximum temperatures is up to 10° C.

57. The method of claim 56, wherein the temperature difference between the maximum temperatures is 5° C.

58. The method of claim 55, wherein, in a first washing step of at least one washing program, washing liquor is heated to a maximum washing liquor temperature that is lower than a maximum rinse aid fluid temperature to which the rinse aid fluid is heated in a rinse aid step.

59. The method of claim 53, wherein the temperature difference between the maximum washing liquor temperature and the maximum rinse aid fluid temperature is at least 10° C.

60. The method of claim 59, wherein the temperature difference is 15° C.

61. The method of claim 55, wherein, during the at least one washing step, a washing liquor temperature essentially does not exceed 45° C., and wherein, in the rinse aid step, a rinse aid fluid temperature reaches at least temporarily reaches 55° C.

62. The method of claim 61, wherein, in the rinse aid step, the rinse aid fluid temperature reaches at least temporarily 60° C.

63. The method of claim 61, wherein the washing liquor temperature essentially does not exceed 40° C.

64. The method of claim 63, wherein the washing liquor temperature essentially does not exceed 35° C.

65. The method of claim 61, wherein the rinse aid fluid temperature at least temporarily exceeds 70° C.

66. The method of claim 65, wherein the rinse aid fluid temperature at least temporarily exceeds 75° C.

67. The method of claim 55, wherein a washing program configured as one of a low-temperature program and a normal program is selected; and wherein, when the low-temperature program is selected, a washing liquor is heated in the washing step to a maximum washing liquor temperature that is lower than a maximum washing liquor temperature to which the washing liquor is heated in the washing step when the normal program is selected.

68. The method of claim 67, wherein a circulation period of the washing step of the low-temperature program is adapted at least to a circulation period of the washing step of the normal program.

69. The method of claim 67, wherein a washing program configured as an intensive program is selected; and wherein, in the washing step of the intensive program, the washing liquor is heated to a maximum washing liquor temperature that is higher than the maximum washing liquor temperature to which the washing liquor is heated in the at least one washing step when the selected normal program is selected.

70. The method of claim 69, wherein a circulation period of the washing step of the low-temperature program is adapted to at least a circulation period of the washing step of the intensive program.

71. The method of claim 55, wherein the washing programs are selected manually by an operator.

72. The method of claim 71, wherein a selection is made by one of using selection elements assigned to each selectable washing program and using a selection element with a plurality of selection options corresponding to a plurality of washing programs.

73. The method of claim 71, wherein a selection is made by using at least one first selection element and a second selection element, wherein at least one selectable washing program is assigned to a predetermined combination of the first and second selection elements.

74. The method of claim 73, wherein each of the selectable washing programs is assigned to at least one of a first group and a second group; wherein washing programs of the first group are assigned to one of one selection element and one selection element with a plurality of selection options corresponding to a plurality of washing programs; and wherein washing programs of the second group are selected by one of simultaneous and successive actuation of the two selection elements.

75. The method of claim 74, wherein, in at least one washing program of the second group, washing liquor is heated to a maximum washing liquor temperature that is lower than a maximum washing liquor temperature to which washing liquor is heated in a washing programs of the first group.
